(19) United States
(12) Patent Application Publication
(10) Pub. No.: US 2002/0138461 A1
(43) Pub. Date: Sep. 26, 2002

(54) Monetary behavior detection in a networked environment method and apparatus

(76) Inventors: Sebastian Sinclair, Limerick, ME (US); Walton Lamar Moore, NorthHampton, MA (US)

Correspondence Address: MICHAEL A. KERR, VIRTUAL LEGAL, 777 E Williams St Ste 211, Carson City, NV, 89701, US

(21) Appl. No.: 09/778,660

(22) Filed: Feb. 6, 2001

(51) Int. Cl. G06F 7/00

(52) U.S. Cl. 707/1

(57) ABSTRACT

Disclosed is a method and apparatus for detecting indicia of problem monetary transaction behaviors. In one embodiment, the invention detects indicia a problem gambling behaviors in a networked gaming environment. In another embodiment, the invention detects indicia of problem trading behavior in a networked securities trading environment. Monetary transactions are monitored in these environments to gather data which is in turn analyzed for indications of problem behaviors. When detected, the problems behaviors are reported and/or remedied in various fashions as indicated in this disclosure.

### BACKGROUND OF THE INVENTION

1. Field of the Invention

The present invention relates generally to pattern behavior detection in networked systems. More particularly, the present invention relates to an apparatus and method for detecting problematic fiscal behaviors in networked monetary transactions. Furthermore, the present invention is particularly applicable to networked casino gaming applications for detecting behaviors that might be indicative of problem gambling.

2. The Prior Art

With the growth of the Internet has come increased emphasis on online transactions. In particular, online monetary transactions in the areas of casino-style gaming and securities trading are growing at a notable pace. Although this growth produces significant fiscal throughput for such online entities, concern is growing regarding certain individuals with behavior disorders partaking in these services.

Some individuals who partake in online gambling or securities trading have difficulties controlling their spending behaviors and/or lose rational control of such behaviors while engaged in these activities. Although these individuals may be a small percentage of the total participants in these activities, many outside entities, including governmental regulators focus on the individuals who cannot or will not control themselves. In the area of online gambling, this has led to reluctance on the part of regulators to approve online gambling in many jurisdictions worldwide. In the area of securities trading, online broke-age houses have come under scrutiny from regulators and the press for “allowing” online “day-traders” to lose substantial sums of money.

Additionally, beyond the Internet online environment, closed network environments exist within casinos and brokerage houses to facilitate an enhanced gambling or trading experience via the use of proprietary network applications. Even outside of the Internet, regulators and others are concerned about problem gambling and compulsive trading behaviors. Although substantial technology comes to bear in these networked environments, the focus is not on the problematic fiscal behaviors of customers, but on the optimization of profit. However, both casinos and brokerage houses are concerned with both public image and perception and use rudimentary methods for attempting to restrain such negative behaviors. For instance, when casino personnel suspect that an individual may be playing in a manner that suggests a problem behavior, the player may be encouraged to take a break or may be handed a “problem gambling” public service brochure. Likewise, in brokerage houses it is acknowledged that undisciplined traders are not necessarily good for long-term business and are diverted when subjectively identified to remedial training or other resources.

Current problem behavior identification approaches in gambling and trading are “hit and miss” at best, as they are substantially subjective in nature and primarily rely on the queries of concerned patrons to employees. It is acknowledged that identifying such problem behavior individuals and directing such individuals to remedial measures is beneficial, from both a casino operator or brokerage point of view, and a regulatory point of view. However, solutions to this problem have been insubstantial at best. Thus, a need exists to better identify problem behaviors in these monetary transaction settings.

### BRIEF DESCRIPTION OF THE INVENTION

To overcome these and other shortcomings of the prior art, disclosed herein is an apparatus and method for identifying problem behavior patterns in monetary transactions in a networked environment. More particularly, the present invention employs a monetary transaction analyzer to detect problematic behavior patterns in monetary transactions.

Online Internet gambling and securities trading occur in a networked environment. As such, a certain amount of data -Ls already provided by a user of the online system to conduct monetary transactions (i.e. user name, initial funding, location of user, etc.). Furthermore, the psychological community has identified certain patterns of behavior as indicative of irrational behaviors in such monetary transactions. However, nobody heretofore has attempted to implement such pattern identification in a substantially real-time networked environment. Instead, it is not until after the fact, when a player or trader has suffered substantial or devastating financial losses, that the player or trader may seek counseling or other help. As can be readily seen, this is often too late to ameliorate negative impacts, and the subject of substantial and increasing criticism from outsiders, such as regulators.

The present invention, for example in the online casino environment, analyzes player betting patterns for indications of problematic gambling behavior. For instance, it is known in the psychological community that one indication of problem betting is a behavior pattern known as “chasing.” Simply put, “chasing” is the irrational belief that although one is losing, it must be time for a win, and thus the player “chases” his/her losses with greater wagers. This behavior is irrational, because with the possible exception of Blackjack (depending on the sophistication of the player)and some other card games, each event (or decision of the randomizing device) is independent from all previous outcomes. By actively monitoring player wagers, which may be accomplished in a networked environment, detection of the “chasing” behavior may occur. Thus, upon detection of such behavior, remedial attention may then be paid to such player in the form of diversion to counseling, wager limiting, or other means deemed required by the circumstances.

One advantage of this system of detection is that it provides a third-party policing mechanism to online operators to deflect criticism from outside sources. Another advantage is that it provides an additional tool to regulators to employ to minimize the potential that problem gamblers are being exploited. The same can be said for online brokerage houses—the behavior patter that is to be detected is the same, just the transaction differs.

As one skilled in the art will appreciate, this analyzing system can be employed in any environment which is networked (so that data can be appropriately gathered). Thus, even closed casino networks or brokerage networks can take advantage of this inventive technology.

It is therefore an object of the present invention to provide a networked behavior pattern detection system.

It is another object of the present invention to provide a behavior pattern recognition system in a networked casino environment.

It is another object of the present invention to provide a behavior pattern recognition system in a networked securities brokerage environment.

It is yet another object of the present invention to provide an alerting mechanism for alerting appropriate personnel of problem behavior detection.

It is a further object of the invention to specifically provide a method for detecting the behavior known as “chasing” in a networked monetary transaction environment.

The invention further relates to machine readable media on which are stored embodiments of the present invention. It is contemplated that any media suitable for retrieving instructions is within the scope of the present invention. By way of example, such media may take the form of magnetic, optical, or semiconductor media. The invention also relates to data structures that contain embodiments of the present invention, and to the transmission of data structures containing embodiments of the present invention.

Viewed from a first vantage point a method for detecting indicia of a problem behavior in a monetary transaction is disclosed comprising operatively coupling at lease one server to a monetary transaction network, monitoring the network for monetary transaction activity, storing the monitored data in a database on the at least one server, analyzing the data to determine the presence of indicia of problem monetary behavior patterns, and storing instances of determined indicia of problem monetary behaviors in the database.

Viewed from another vantage point a program storage device readable by a machine, tangibly embodying a program of instructions executable by the machine to perform a method for detecting indicia of a problem behavior in a monetary transaction is disclosed, the method comprises operatively coupling at lease one server to a monetary transaction network, monitoring the network for monetary transaction activity, storing the monitored data in a database on the at least one server, analyzing the data to determine the presence of indicia of problem monetary behavior patterns, and storing instances of determined indicia of problem monetary behaviors in the database.

Viewed from yet another vantage point a problem monetary transaction indicia detector for a monetary transaction networked system is disclosed, comprising at least one server operatively coupled to the monetary transaction network, the at least one server configured to monitor the monetary transactions on the network, a database maintained on the at least one server, the database configured to store the monitored monetary transactions, an analyzer maintained within the at least one server and operatively coupled to the database for analyzing the stored monitored monetary transactions to determine the presence of indicia of problem monetary behavior patterns, and a storage space in the at least one server for storing instances of the indicia as prescribed by the analyzer.

These and other objects of the present invention will become manifest from the further descriptions and claims of the invention provided herein.

### BRIEF DESCRIPTION OF THE DRAWING FIGURES

FIG. 1 is a schematic diagram of an Internet implementation of the present invention.

FIG. 2 is a schematic diagram of a closed network casino environment implementation of the present invention.

FIG. 3 is a flowchart of the general process of the present invention.

FIG. 4 is a profile questionnaire implicated by the process of FIG. 3 of the present invention.

FIG. 5 is a data structure implicated by the process of FIG. 3 of the present invention.

FIG. 6 is a flowchart of the analyzer process implicated by the process of FIG. 3 of the present invention.

FIG. 7 is a survey implicated by the process of FIG. 3 of thee present invention.

FIG. 8 is an exemplary data plot of exemplary data take from FIG. 5 of the present invention.

### DETAILED DESCRIPTION OF THE INVENTION

Persons of ordinary skill in the art will realize that the following description of the present invention is illustrative only and not in any way limiting. Other embodiments of the invention will readily suggest themselves to such skilled persons having the benefit of this disclosure.

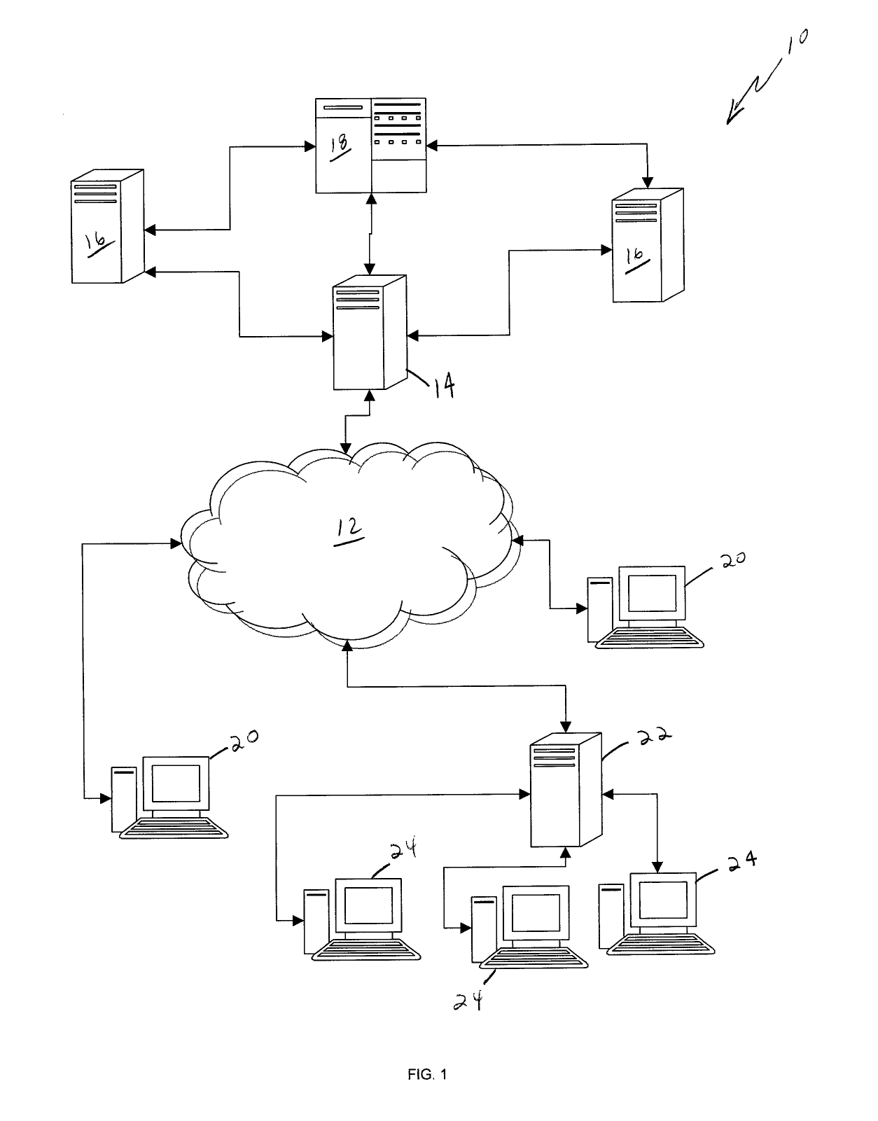

Referring now to the drawing figures wherein like reference numerals depict like parts throughout the various drawing figures, FIG. 1 depicts an overview of the present invention 10 in an online Internet environment. Internet cloud 12 is the medium for communication between web server 14 and workstations 20. Workstations 20 may be any of a variety of devices so long as they are configured to communicate via the Internet with web server 14. Examples of devices 20 include desktop computers, laptop computers, personal data assistants (PDAs), wireless telephones, two-way pagers, and any other device capable of two-way communication via the Internet.

Web server 14 is configured to transmit web pages and other data to devices 20. For instance, in an online gambling system, web server 14 may be configured to display to users at devices 20 wagering opportunities. Likewise, is an online securities trading system, web server 14 may be configured to accept trades from devices 20. Furthermore, as will be appreciated by those skilled in the art, users may be using devices within another network defined by way of example as server 22 and workstations 24.

Additionally, servers 16 are typically present to handle one or more other processes required to facilitate service at web server 14. For instance, one server 16 may be configured to maintain a user database, while another may be configured to maintain secondary information useful to users such as betting forms, stock histories, and the like. Server 18 is configured in this embodiment as a real-time behavior analysis database. Each of these servers 14, 16, 18 are thus configured to communicate with each other, but not necessarily with devices 20. That is the main role of server 14.

Server 18 then, as will be explained in more detail below, is configured to track each monetary transaction for each user and analyze the transaction history to determine whether a problem behavior has been detected. When such behaviors are detected, server 18 will report those flagged events to appropriate personnel and may cause remedial interaction to occur with a user at device 20 via web server 14. Reporting may occur by way of printer (not shown) or any other networked communication means.

Thus, from FIG. 1 may be seen a typical online gambling or securities trading environment, except for server 18. Where server 18, which may in reality be one or more server-s, or a software system on existing servers, is configured to provide a behavior detection system and database as explained in further detail herein below.

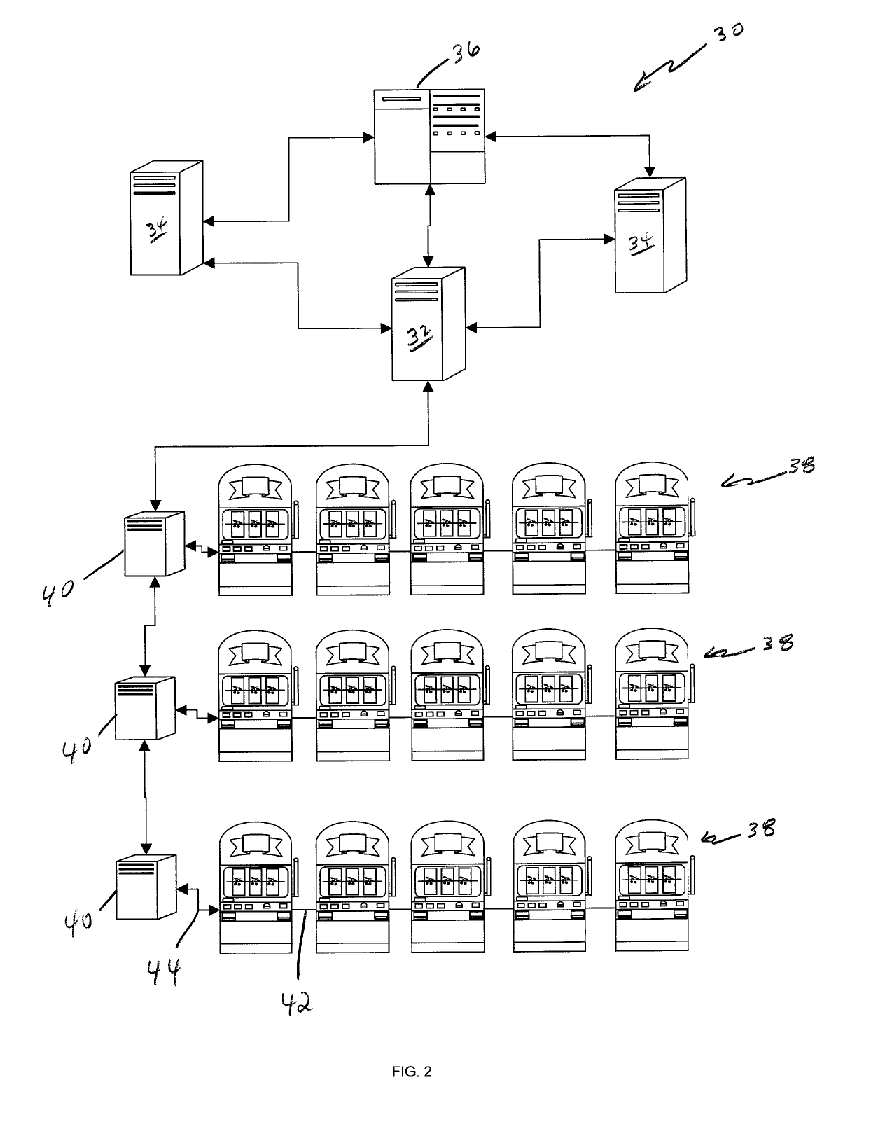

As will be appreciated by those skilled in the art, the internet (or web) is but a network of computer networks. Thus, application of this system to a single closed network is a subset of this Internet application. An example of such a closed-network system 30 is depicted in FIG. 2. It should be noted that the network servers 32, 34, and 36 in this closed network are quite similar, but not identical in purpose to, the servers depicted in FIG. 1.

That is, for example, the network depicted in FIG. 2 is intended to represent a standard casino (“brick and mortar”) network environment. Shown are a plurality of gaming devices (shown as slot machines) 38 networked together and controlled initially by bank controllers 40. The bank controllers 40, as will be appreciated by those skilled in the art, act as a kind of traffic cop between the banks of machines 38 and the network servers 32, 34, and 36. Traditional network server 32 and 34 perform such functions as player tracking, accounting, and progressive wagering functionality, among other things. Unique to this invention, not unlike FIG. 1, is server 36 which performs the function of wager tracking, behavior analysis, and reporting.

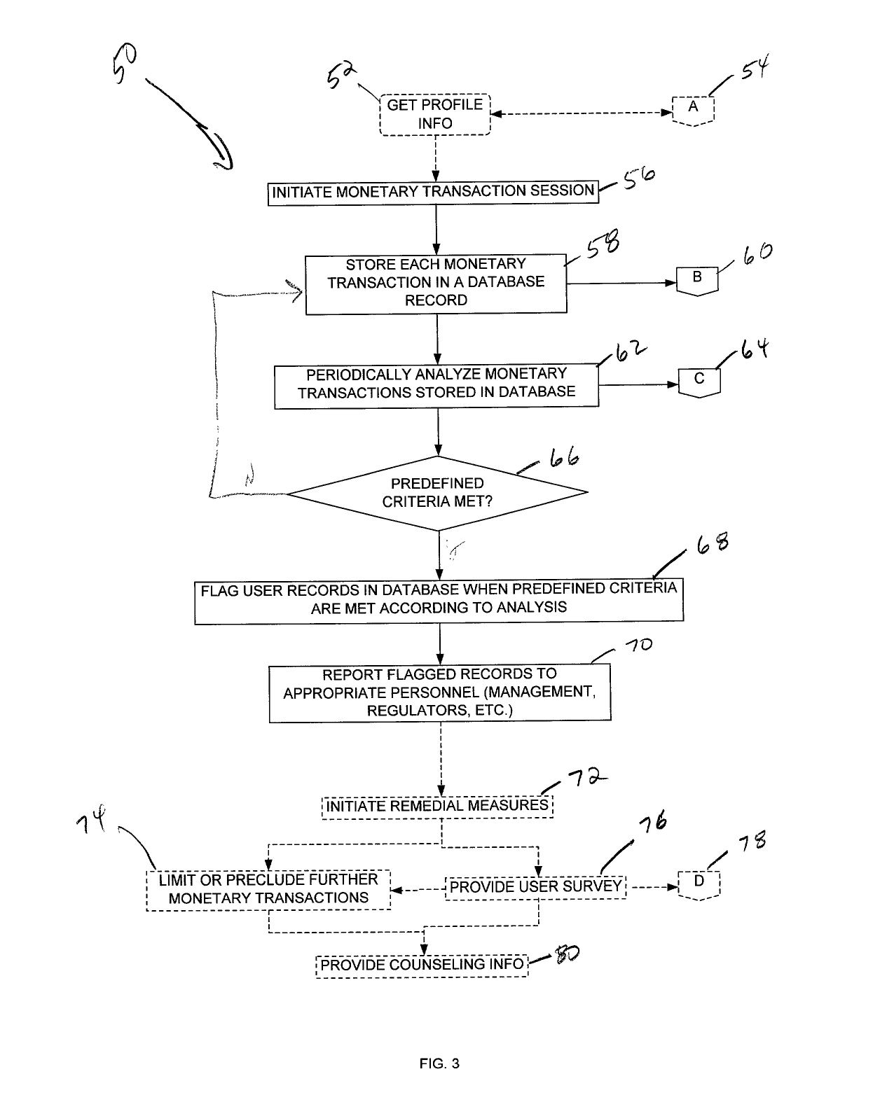

The process by which this wager tracking and behavior detection generally takes place is depicted in the flowchart at FIG. 3. Generally, the first action in the process is to gather user profile information as shown at optional block 52. This is an optional block in that it is not essential to the process, but is preferred. More robust analysis may be performed when certain additional profile or demographic information is available, however, this system analyzer may still be implemented without this information and achieve results heretofore unknown.

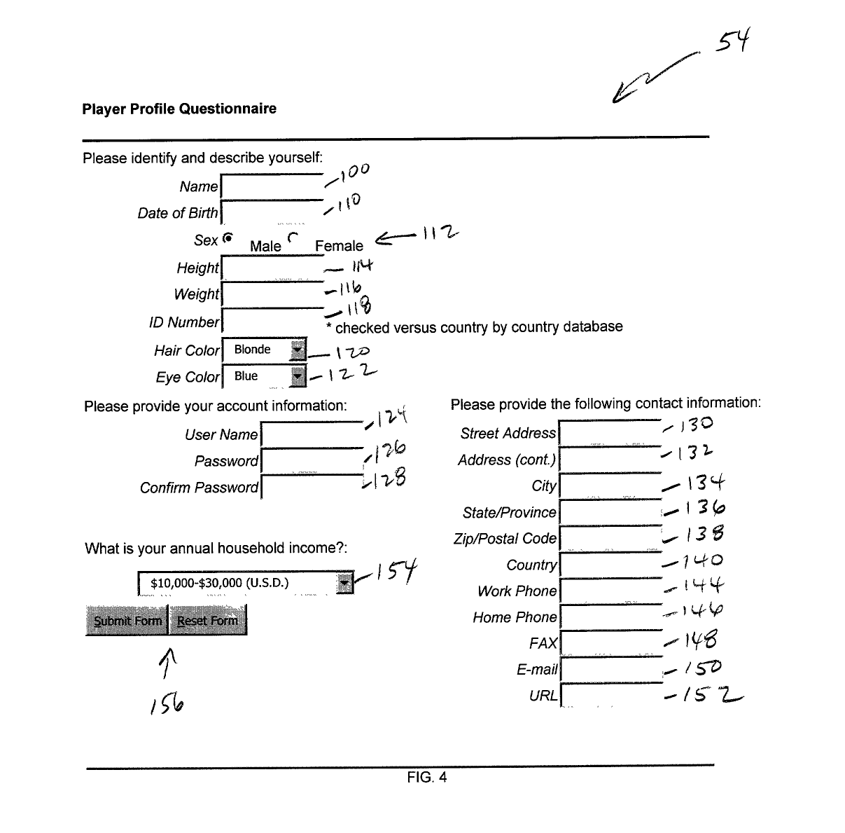

Thus, as shown in FIG. 3, the profile questionnaire is an off-page process 54. Turning to FIG. 4, the player profile questionnaire is presented. It is intended that users complete this information prior to initiating play (i.e. when setting up a new internet gambling account, joining a new casino player club, or other like initiation point . The preferred, though not limiting, information sought via player questionnaire 54 includes, name 100, date of birth 110, sex 112, height 114, weight 116, identification number 118, as well as hair and eye color 120 and 122. This data is not unlike data gathered by persons in the psychological community to allow for the possibility of further developing other correlations in the future. Additionally, other information generally necessary to establish a new user account is solicited such as user name 124, password 126, password confirmation 128, address information 130, 132, 134, 136, 138, and 140, as well as other contact information 144, 146, 148, 150, and 152. Also sought is user income information 154 as this is also information sought by persons in the psychological community that is deemed relevant to monetary transaction behavior problem identification. Also found in the electronic form of this questionnaire are virtual buttons 156 for submitting the electronic form to the appropriate server.

Once this profile information is optionally gathered, and turning back now to FIG. 3, users are allowed to initiate monetary transactions 56 (for example by placing wagers). That is, in the online casino environment, players will have established an account (as is presently customary) from which the players may make wagers. Those monetary transactions or wagers are stored in a database 58 (such as at server 18 in FIG. 1 or server 36 at FIG. 2). More detail regarding the database structure is found off-page indicated by 60.

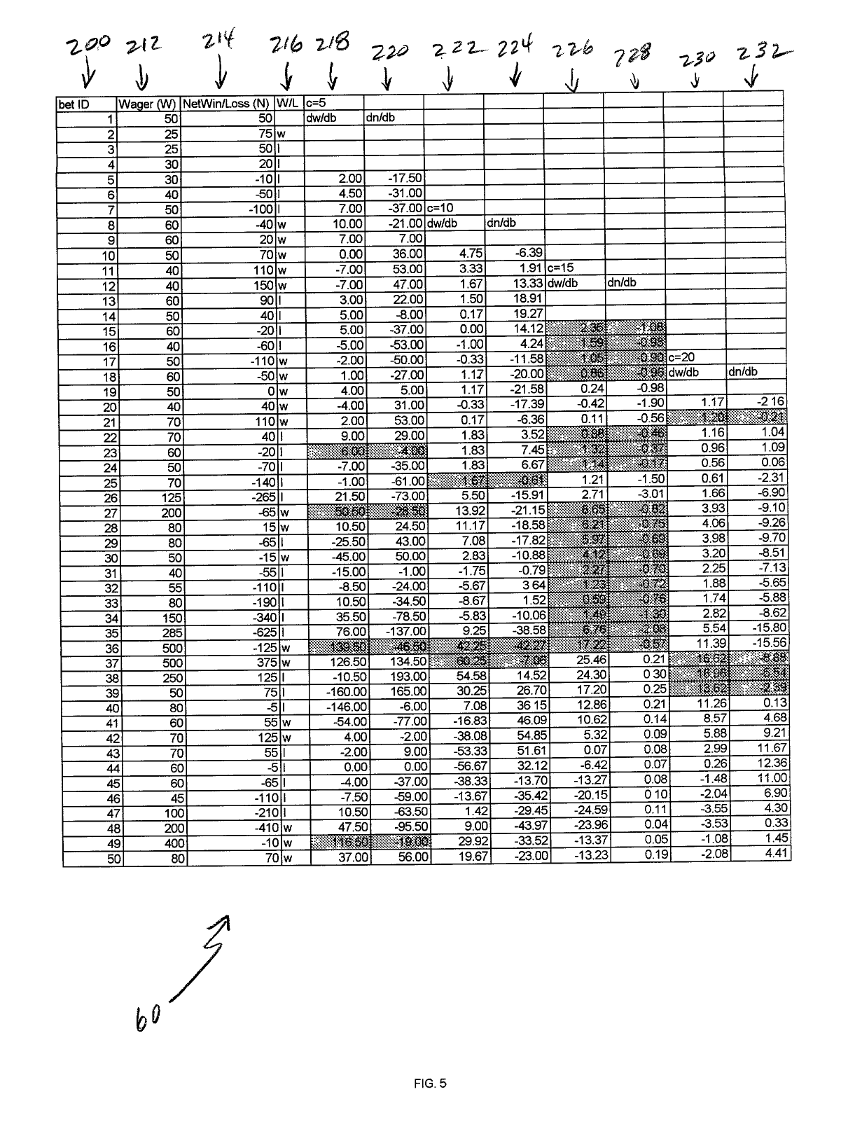

Turning now to data structure 60 as exemplarily shown in FIG. 5, a plurality of data fields 200 through 232 are indicated. Each wager has its own identification or transaction number as shown in field 200. For each wager, the amount of wager is recorded 212, along with net win and loss on that wager 214, and a win/loss flag 216. This base data :s then analyzed (as will be discussed below) to form the results of fields 220, 224, 226, 228, 230, and 232. Each of these fields 220 through 232 are similar except for the data history or period used prior to analysis starting. That is, the inventors have learned that results vary according to the amount of data acquired prior to subjecting the data to the analyzer process. Thus, it is now understood that it may be useful to utilize multiple differing periods of data to establish greater accuracy in identifying problem behaviors. For example, one skilled in the art will appreciate that different gambling activities have different frequencies of play. An individual who focuses his gambling behavior in off-track betting on horse races will have at most 20 bets in a day. For that individual, chasing may occur relatively quickly compared to a slot machine player, for whom twenty bets can be accomplished in three minutes or less. However, it is not intended that this invention be limited to utilizing multiple periods since it is understood that one specified sampling period might be sufficient. However, it is acknowledged that plural sampling methods cross-referenced for behavior flags is preferred. The gray-shaded data elements indicate possible behavior problems. How that result is arrived at is explained next at 62 in FIG. 3.

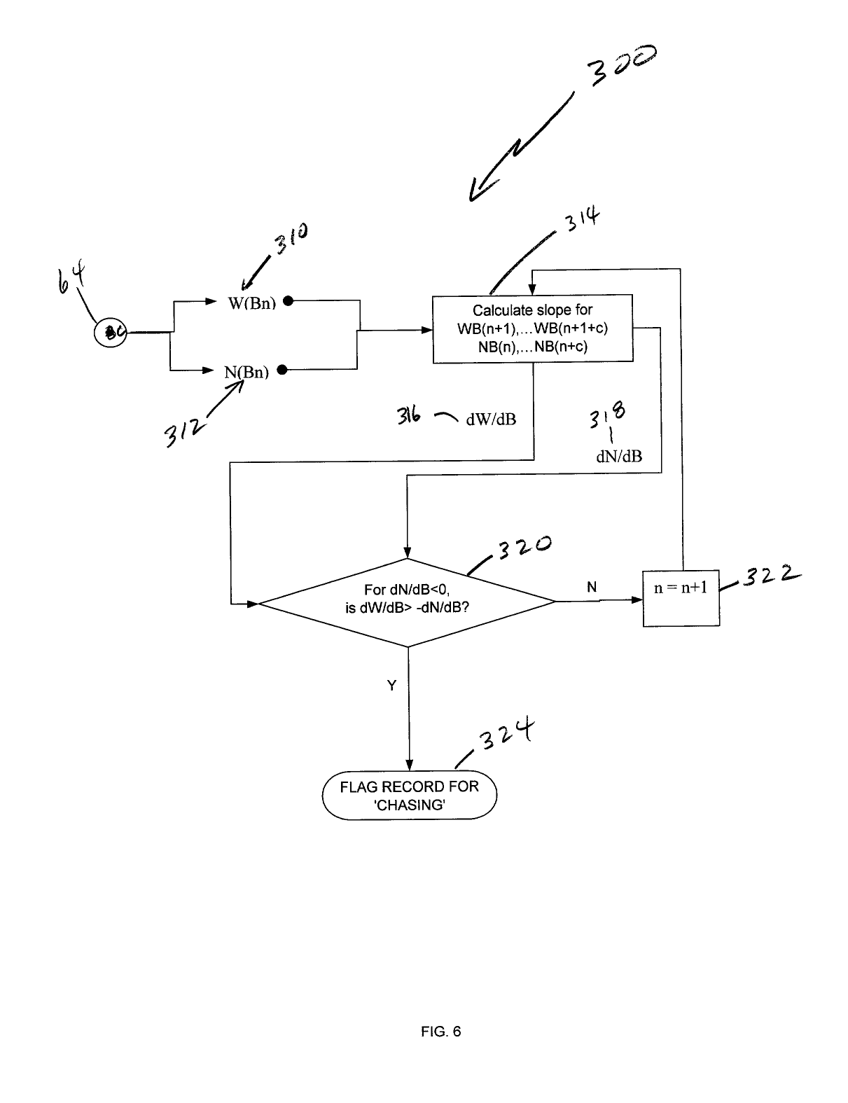

The data is analyzed at block 62 in FIG. 3 which in turn results in reference to off-page operation 64. Turning then to FIG. 6, analyzer 300 starting at 64 is depicted in flow diagram form. The analysis is performed by taking as inputs the wagers 310 (from field 212 of data record 60 of FIG. 5) and net gains/losses 312 (from field 214 of data record 60 of FIG. 5). Then a slope is calculated for the wagers and net gains/losses 314 (which may also be viewed as the rate of wagering and rate of winning/losing).

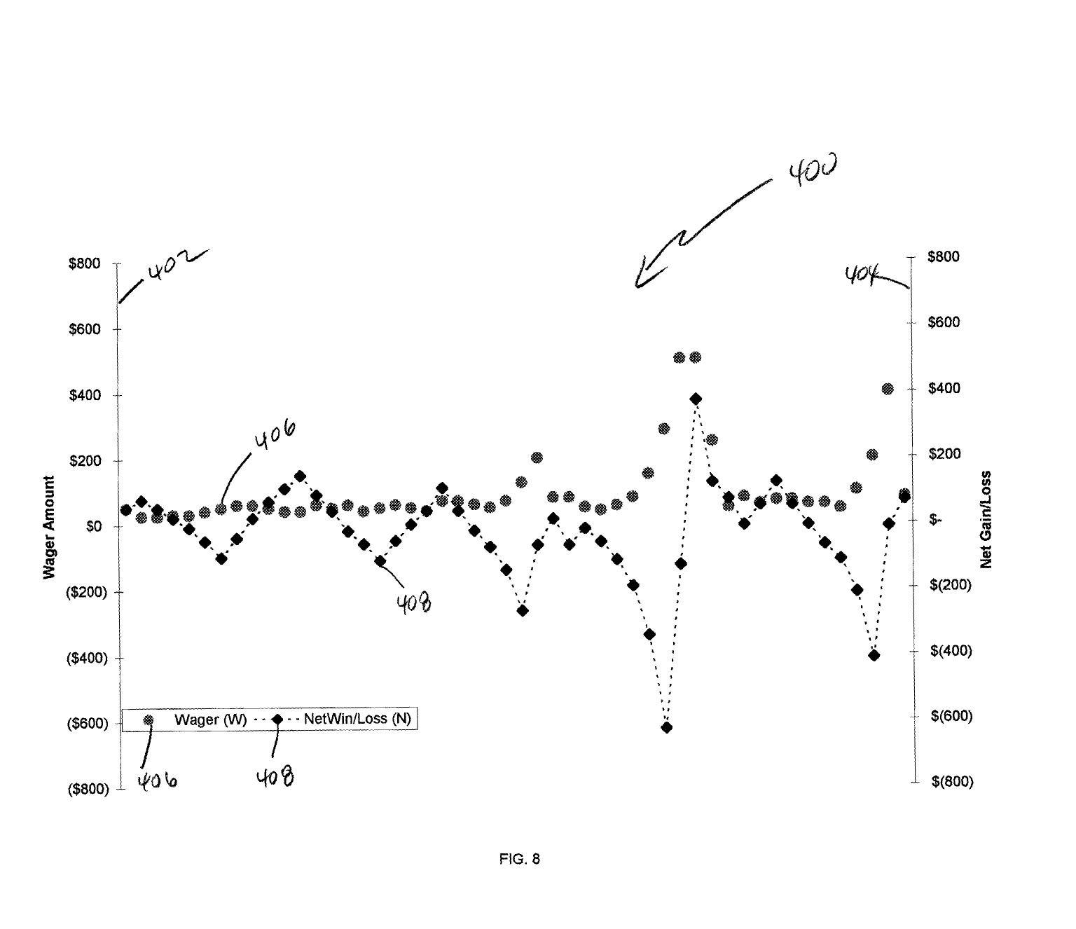

By comparing these slopes a determination of at least one behavior can be made; that is, “chasing.” Put another way, if a player is losing but increasing wagers, the problem behavior of “chasing” is implicated. Viewed from another point of view, and turning to decision diamond 320, if dN/dB<0 (player is net losing), and dW/dB>−dN/dB (the player's wager rate is greater than the loss rate), then the record should be flagged for “chasing” as in 324, otherwise, the data will be analyzed again after another wager is made as in block 322. A graphical depiction of this method is provided at FIG. 8.

Returning again to the process of FIG. 3, once the analysis is conducted, action may be indicated. However, as is indicated at decision diamond 66, a certain predefined criteria set may be required before additional remedial action is taken. That is, if a player chases losses one time, that may not be adequate for remedial action. Thus, a predefined criteria set must be met before further action is taken (however, this predefined criteria could be set for each and every instance of chasing behavior and still be within the scope of this invention). Should we have a figure that is a sample report? Not necessary, but wouldn't hurt.

Next, then if the predefined criteria are met, the players record is flagged as in block 68 otherwise the process returns to block 58 to record and analyze more data. Once a record is flagged, that record is reported to appropriate personnel at block 70. This can be in the form of an email, an electronic text message alert, a printout report that is printed periodically, or any other like means for alerting responsible persons of the problem behavior detected.

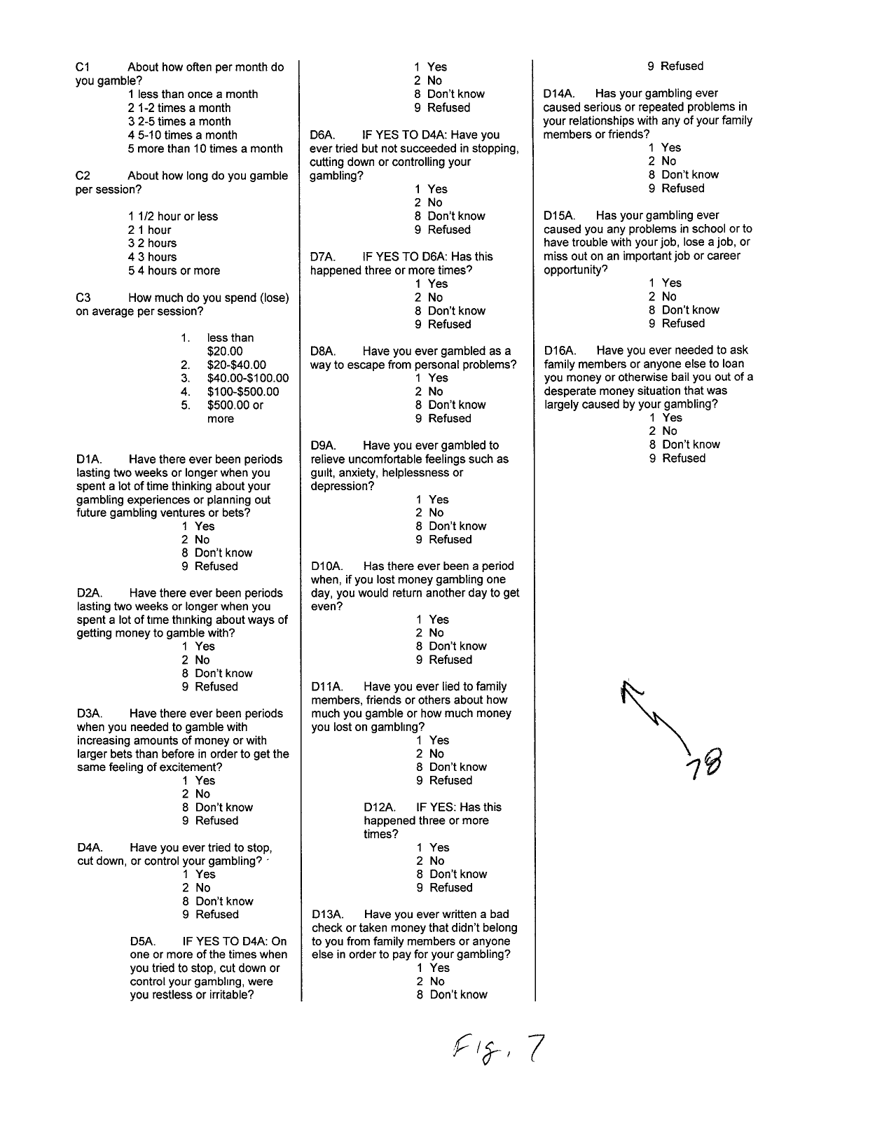

Thereafter, a plurality of optional remedial actions may be employed as in block 72. For example, the player could be automatically or manually limited or precluded with regard to future wagers as in block 74. Additionally, the player may be required to take a survey at block 76 designed to further establish problem gambling symptomologies. An example of such a survey is indicated by off-page indicator 78 and provided at FIG. 7. The use of such a survey may be a precursor to other remedial measures to establish more specifically whether a problem gambling pattern is established. Another remedial measure, depending on the results of the survey 78 or not could be to provide counseling information to the player so that the player may seek help for the behavior indicated. Yet another remedial measure could be the implementation of betting constraints or limits that could be imposed by the player voluntarily or by a third-party involuntarily.

“Chasing” is but one detectable problem behavior. Other detectable behaviors are envisioned to be within the scope of this invention as well. For instance, by way of example again in the gambling environment, but not limitation, “loss of control” is another behavior which is detectable. In the psychological research community, “loss of control” is characterized by spending more time and/or losing more money than was intended. In betting patterns, this pattern would be characterized by statistically rare or anomalous wagers, session lengths, and/or net losses per session.

Of course, this example requires background betting information to build a statistical base. For instance, wagers for a one year period may be necessary to allow statistical rigor, or at least perhaps 50 past wagers. With a statistical history of wagers, both an average wager and standard deviation can be readily determined. The object of this method to detect “loss of control” is to establish a predefined deviation that triggers a flag for “loss of control.”

For instance, for every new wager W, the average wager μ can be calculated as well as the standard deviation δ. Furthermore, calculation of the number of standard deviations a present wager W is from the average may be determined from Z=(W−μ)/δ. It is assumed that wagers W, should, given sufficient data, follow a normal distribution. Thus, if the number Z, calculated for each wager W, is higher than a predefined Z_{c}, then the data record should be flagged as indicated for “loss of control.” Stated another way, if a wager W_{c} is greater than that as calculated for a predefined Z_{c}, then the data record should be flagged as indicative of “loss of control.” Thus for a predefined Z_{c}, the wager amount indicative of “loss of control” may be derived from W_{c}=Z_{c}δ+μ. An exemplary data table illustrative of this behavior pattern detection scheme is as shown in Table 1 below.

TABLE 1

| | | | Z_{c} = 1. | Z_{c} = 1.9 | Z_{c} = 3. |
|---|---|---|---|---|---|
| | | Standard | 5 | 6 | 0 |
| | Average (μ) | Deviation (δ) | W_{c}($) | W_{c}($) | W_{c}($) |
| Gambler 1 | $50 | $10 | $65 | $70 | $80 |
| Gambler 2 | $400 | $50 | $475 | $500 | $550 |
| Gambler 3 | $400 | $200 | $700 | $800 | $1000 |

Thus, at Z_{c}=1.96, the likelihood of a wager W_{c} occurring that high is 2.5%. At Z_{c}=3.0, the likelihood of a wager WC occurring that high is 0.13%. And, at Z_{c}=1.5, the likelihood of a wager W_{c} occurring that high is 6.7%. Therefore, depending on the level Z_{c} is predefined at for flagging, certain wagers W_{c} would be deemed within the norm, and others flagged as indicators of “loss of control.” The tolerance can be then adjusted depending on experience and/or imposed by regulation as necessary. Therefore, from Table 1, if Z_{c} is predefined at 3.0, then Gambler 1's record will be flagged when wagers W_{c} greater than $80 are made, and Gambler 2's record will be flagged when wagers W_{c} greater than $550 are made, and Gambler 3's record will be flagged when wagers W_{c} greater than $1000 are made. Interestingly, each gambler is allowed different variances based on past wagering behavior. This is exactly as it should be given an understanding of this behavior problem.

As will be appreciated by those skilled in the art now informed by this disclosure, the same process is available for securities trading. Instead of wagers, trades will be recorded and analyzed. Interestingly, the same behaviors are detectable. This should not be overly surprising, as many pundits equate day trading to gambling. Thus, although the monetary transaction is for a different purpose, trading and wagering across a network provide the same problem potential, and thus this invention offers the same solution. Furthermore, as will also be understood by those skilled in the art, a casino gaming network as exemplarily shown in FIG. 2 provides the same problem as the online gambling environment. Further, will the ever-expanding player club opportunities and player tracking already happening, this invention is a logical extension for self-policing by casinos or regulatory direction.

While embodiments and applications of this invention have been shown and described, it would be apparent to those skilled in the art that many more modifications than mentioned above are possible without departing from the inventive concepts herein. The invention, therefore, is not to be restricted except in the spirit of the appended claims.

What is claimed is:

1. A method for detecting indicia of a problem behavior in a monetary transaction, comprising in combination:
operatively coupling at lease one server to a monetary transaction network;
monitoring said network for monetary transaction activity; storing said monitored data in a database on said at least one server;
analyzing said data to determine the presence of indicia of problem monetary behavior patterns; and
storing instances of determined indicia of problem monetary behaviors in said database.

2. The method for detecting indicia of a problem behavior in a monetary transaction of claim 1 further comprising maintaining said database on said at least one server.

3. The method for detecting indicia of a problem behavior in a monetary transaction of claim 2 further comprising reporting said instances of determined indicia of problem monetary behaviors to specified personnel.

4. The method for detecting indicia of a problem behavior in a monetary transaction of claim 3 further comprising soliciting profile data from users of said monetary transaction network.

5. The method for detecting indicia of a problem behavior in a monetary transaction of claim 4 further comprising initiating remedial measures with respect to those users indicated by said instances of determined indicia of problem monetary behaviors.

6. The method for detecting indicia of a problem behavior in a monetary transaction of claim 5 further comprising providing a survey to users indicated by said instances of determined indicia of problem monetary behaviors as a said remedial measure.

7. The method for detecting indicia of a problem behavior in a monetary transaction of claim 5 further comprising constraining monetary transaction activity of users indicated by said instances of determined indicia of problem monetary behaviors as a said remedial measure.

8. A program storage device readable by a machine, tangibly embodying a program of instructions executable by the machine to perform a method for detecting indicia of a problem behavior in a monetary transaction, said method comprising in combination:
operatively coupling at lease one server to a monetary transaction network;
monitoring said network for monetary transaction activity;
storing said monitored data in a database on said at least one server;
analyzing said data to determine the presence of indicia of problem monetary behavior patterns; and
storing instances of determined indicia of problem monetary behaviors in said database.

9. The method for detecting indicia of a problem behavior in a monetary transaction of claim 8 further comprising maintaining said database on said at least one server.

10. The method for detecting indicia of a problem behavior in a monetary transaction of claim 9 further comprising reporting said instances of determined indicia of problem monetary behaviors to specified personnel.

11. The method for detecting indicia of a problem behavior in a monetary transaction of claim 10 further comprising soliciting profile data from users of said monetary transaction network.

12. The method for detecting indicia of a problem behavior in a monetary transaction of claim 11 further comprising initiating remedial measures with respect to those users indicated by said instances of determined indicia of problem monetary behaviors.

13. The method for detecting indicia of a problem behavior in a monetary transaction of claim 12 further comprising providing a survey to users indicated by said instances of determined indicia of problem monetary behaviors as a said remedial measure.

14. The method for detecting indicia of a problem behavior in a monetary transaction of claim 12 further comprising constraining monetary transaction activity of users indicated by said instances of determined indicia of problem monetary behaviors as a said remedial measure.

15. A problem monetary transaction indicia detector for a monetary transaction networked system, comprising in combination:
at least one server operatively coupled to the monetary transaction network, said at least one server configured to monitor the monetary transactions on the network;
a database maintained on said at least one server, said database configured to store said monitored monetary transactions;
an analyzer maintained within said at least one server and operatively coupled to said database for analyzing said stored monitored monetary transactions to determine the presence of indicia of problem monetary behavior patterns; and
a storage space in said at least one server for storing instances of said indicia as prescribed by said analyzer.

16. The problem monetary transaction indicia detector for a monetary transaction networked system of claim 15 further comprising a plurality of workstations on the monetary transaction network, said workstations configured to place monetary wagers.

17. The problem monetary transaction indicia detector for a monetary transaction networked system of claim 15 further comprising a plurality of workstations on the monetary transaction network, said workstations configured to buy and sell securities.

18. The problem monetary transaction indicia detector for a monetary transaction networked system of claim 15 further comprising a plurality of game devices operatively coupled to the monetary transaction network, said game devices configured to accept monetary wagers.

19. The problem monetary transaction indicia detector for a monetary transaction networked system of claim 15 further comprising a plurality of workstations operatively coupled to the internet which is in turn operatively coupled to the monetary transaction network, said at least one server configured to provide wagering opportunities to players at said workstations.

20. The problem monetary transaction indicia detector for a monetary transaction networked system of claim 15 further comprising a plurality of workstations operatively coupled to the internet which is in turn operatively coupled to the monetary transaction network, said at least one server configured to provide securities trading opportunities to players at said workstations.
